(19) United States
(12) Patent Application Publication
(10) Pub. No.: US 2014/0141830 A1
(43) Pub. Date: May 22, 2014

(54) Transmission Power

(71) Applicants: Peter Skov, Beijing (CN); Xiaoyi Wang, Wheeling, IL (US); Yuyu Yan, Beijing (CN)

(72) Inventors: Peter Skov, Beijing (CN); Xiaoyi Wang, Wheeling, IL (US); Yuyu Yan, Beijing (CN)

(21) Appl. No.: 14/124,515

(22) PCT Filed: Jun. 8, 2011
(86) PCT No.: PCT/CN2011/075446

§ 371 Date: Feb. 4, 2014

(51) Int. Cl. H04W 52/24

(52) U.S. Cl. CPC H04W 52/242
USPC 455/522

(57) ABSTRACT

As part of a communication technique involving a plurality of access nodes cooperatively detecting an uplink transmission from a communication device: detecting at said communication device access node-specific reference signals transmitted by respective ones of said plurality of access nodes; and calculating a pathloss value for at least one of said plurality of access nodes from a measurement of a power at which a respective one of said reference signals is detected at said communication device.

Communicating over a wireless interface can involve cooperatively detecting a transmission from a communication device at a plurality of access nodes.

A communication device can be understood as a device provided with appropriate communication and control capabilities for enabling use thereof for communication with other parties via one or more wireless interfaces. The communication may comprise, for example, communication of voice, electronic mail (email), text messages, data, multimedia and so on. A communication device typically enables a user of the device to make and receive transmissions via a wireless interface and can thus be used for accessing various service applications via a radio access network.

A radio access network typically operates in accordance with a wireless standard and/or with a set of specifications which set out what the various elements of the system are permitted to do and how that should be achieved. Examples include GSM (Global System for Mobile) EDGE (Enhanced Data for GSM Evolution) Radio Access Networks (GERAN), Universal Terrestrial Radio Access Networks (UTRAN), and evolved Universal Terrestrial Radio Access Networks (EUTRAN).

One technique of communicating over a wireless interface relies on combining the results of detecting a transmission from a communication device at a plurality of access nodes; or detecting a transmission based on signals received at a plurality of access nodes; or more generally, involving a plurality of access nodes in the detection of a transmission.

The inventors for the present application have identified the challenge of controlling the uplink transmission power of a communication device in such a technique of cooperatively detecting a transmission from a communication device at a plurality of access nodes, particularly where the plurality of access nodes are closely associated with one another.

It is an aim of the present invention to meet this challenge.

There is provided a method, comprising: as part of a communication technique involving a plurality of access nodes cooperatively detecting an uplink transmission from a communication device: detecting at said communication device access node-specific reference signals transmitted by respective ones of said plurality of access nodes; and calculating a pathloss value for at least one of said plurality of access nodes from a measurement of a power at which a respective one of said reference signals is detected at said communication device.

According to one embodiment, the method further comprises: determining a transmission power parameter for said uplink transmission from said communication device at least partly on the basis of a pathloss value calculated from a measurement of a power at which one of said reference signals is received at said communication device, and information received at the communication device about a transmission power for said one of said reference signals.

According to one embodiment, the method further comprises: receiving at said communication device an indication as to which of said access-node specific reference signals to use for determining said transmission power parameter.

According to one embodiment, the method further comprises: receiving said indication as part of downlink control information specific to said uplink transmission.

According to one embodiment, the method further comprises receiving said indication as part of downlink control information about the grant of radio resources for said uplink transmission from said communication device.

According to one embodiment, the method further comprises: receiving said indication as part of a message including control information relevant to a plurality of transmissions from said communication device.

According to one embodiment, the method further comprises determining at said communication device respective pathloss values for each of said plurality of access nodes, and determining said transmission power parameter on the basis of one of said pathloss values selected according to a predetermined rule.

According to one embodiment, the method further comprises determining said transmission power parameter on the basis of one said pathloss values selected so as to optimise said transmission power parameter.

According to one embodiment, the method further comprises detecting at said communication a reference signal common to all of said plurality of access nodes and broadcast by all of said plurality of access nodes.

According to one embodiment, said plurality of access nodes includes a set of access nodes operating under the control of another of said plurality of access nodes.

According to one embodiment, said access-node specific reference signals are channel state information reference signals.

There is also provided a method, comprising: in a communication technique involving a plurality of access nodes cooperatively detecting an uplink transmission from a communication device: broadcasting access node-specific reference signals from respective ones of said access nodes; and transmitting information about respective transmission powers of said access-node specific reference signals.

According to one embodiment, the method further comprises: transmitting to said communication device an indication as to which of said access-node reference signals to use for determining a transmission power parameter for said uplink transmission.

According to one embodiment, the method further comprises: transmitting said indication as part of downlink control information specific to said uplink transmission from said communication device.

According to one embodiment, the method further comprises transmitting said indication as part of downlink control information about the grant of radio resources for said uplink transmission from said communication device.

According to one embodiment, the method further comprises: transmitting said indication as part of a message including control information relevant to a plurality of transmissions from said communication device.

According to one embodiment, the method further comprises: broadcasting from all of said plurality of access nodes a reference signal common to all of said plurality of access nodes.

According to one embodiment, said plurality of access nodes includes a set of access nodes operating under the control of another of said plurality of access nodes.

According to one embodiment, said access-node specific reference signals are channel state information reference signals.

There is also provided a method, comprising: in a communication system involving a plurality of access nodes cooperatively detecting an uplink transmission from a communication device: measuring the respective received powers at which one or more earlier transmissions from said communication device is detected at each of said access nodes, determining whether any of said received powers exceeds a predetermined threshold value, and, if so, transmitting to said communication device a power correction value indicative of excessive transmission power.

According to one embodiment, said plurality of access nodes includes a set of access nodes operating under the control of another of said plurality of access nodes.

There is also provided an apparatus comprising: a processor and memory including computer program code, wherein the memory and computer program code are configured to, with the processor, cause the apparatus to: as part of a communication technique involving a plurality of access nodes cooperatively detecting an uplink transmission from a communication device: detect at said communication device access node-specific reference signals transmitted by respective ones of said plurality of access nodes; and calculate a pathloss value for at least one of said plurality of access nodes from a measurement of a power at which a respective one of said reference signals is detected at said communication device.

According to one embodiment, said memory and computer program code are configured to, with the processor, cause the apparatus to: determine a transmission power parameter for said uplink transmission from said communication device at least partly on the basis of a pathloss value calculated from a measurement of a power at which one of said reference signals is received at said communication device, and information received at the communication device about a transmission power for said one of said reference signals.

According to one embodiment, said memory and computer program code are configured to, with the processor, cause the apparatus to: receive at said communication an indication as to which of said access-node specific reference signals to use for determining said transmission power parameter.

According to one embodiment, said memory and computer program code are configured to, with the processor, cause the apparatus to: receive said indication as part of downlink control information specific to said uplink transmission.

According to one embodiment, said memory and computer program code are configured to, with the processor, cause the apparatus to receive said indication as part of downlink control information about the grant of radio resources for said uplink transmission from said communication device.

According to one embodiment, said memory and computer program code are configured to, with the processor, cause the apparatus to: receive said indication as part of a message including control information relevant to a plurality of transmissions from said communication device.

According to one embodiment, said memory and computer program code are configured to, with the processor, cause the apparatus to determine at said communication device respective pathloss values for each of said plurality of access nodes, and determine said transmission power parameter on the basis of one of said pathloss values selected according to a predetermined rule.

According to one embodiment, said memory and computer program code are configured to, with the processor, cause the apparatus to determine said transmission power parameter on the basis of one said pathloss values selected so as to optimise said transmission power parameter.

According to one embodiment, said memory and computer program code are configured to, with the processor, cause the apparatus to detect at said communication a reference signal common to all of said plurality of access nodes and broadcast by all of said plurality of access nodes.

According to one embodiment, said plurality of access nodes includes a set of access nodes operating under the control of another of said plurality of access nodes.

According to one embodiment, said access-node specific reference signals are channel state information reference signals.

There is also provided an apparatus comprising: a processor and memory including computer program code, wherein the memory and computer program code are configured to, with the processor, cause the apparatus to: in a communication technique involving a plurality of access nodes cooperatively detect an uplink transmission from a communication device: broadcast access node-specific reference signals from respective ones of said access nodes; and transmit information about respective transmission powers of said access-node specific reference signals.

According to one embodiment, said memory and computer program code are configured to, with the processor, cause the apparatus to: transmit to said communication device an indication as to which of said access-node reference signals to use for determining a transmission power parameter for said uplink transmission.

According to one embodiment, said memory and computer program code are configured to, with the processor, cause the apparatus to: transmit said indication as part of downlink control information specific to said uplink transmission from said communication device.

According to one embodiment, said memory and computer program code are configured to, with the processor, cause the apparatus to transmit said indication as part of downlink control information about the grant of radio resources for said uplink transmission from said communication device.

According to one embodiment, said memory and computer program code are configured to, with the processor, cause the apparatus to: transmit said indication as part of a message including control information relevant to a plurality of transmissions from said communication device.

According to one embodiment, said memory and computer program code are configured to, with the processor, cause the apparatus to broadcast from all of said plurality of access nodes a reference signal common to all of said plurality of access nodes.

According to one embodiment, said plurality of access nodes includes a set of access nodes operating under the control of another of said plurality of access nodes.

According to one embodiment, said access-node specific reference signals are channel state information reference signals.

There is also provided an apparatus comprising: a processor and memory including computer program code, wherein the memory and computer program code are configured to, with the processor, cause the apparatus to: in a communication system involving a plurality of access nodes cooperatively detecting an uplink transmission from a communication device: measure the respective received powers at which one or more earlier transmissions from said communication device is detected at each of said access nodes, determine whether any of said received powers exceeds a predetermined threshold value, and, if so, transmit to said communication device a power correction value indicative of excessive transmission power.

According to one embodiment, said plurality of access nodes includes a set of access nodes operating under the control of another of said plurality of access nodes.

There is also provided an apparatus configured to carry out any of the above methods.

There is also provided user equipment and a set of access nodes comprising the above apparatus.

According to one embodiment, the set of access nodes comprises a macro eNodeB and one or more remote radio heads or pico eNodeBs.

There is also provided a computer program product comprising program code means which when loaded into a computer controls the computer to: as part of a communication technique involving a plurality of access nodes cooperatively detecting an uplink transmission from a communication device: detect at said communication device access node-specific reference signals transmitted by respective ones of said plurality of access nodes; and calculate a pathloss value for at least one of said plurality of access nodes from a measurement of a power at which a respective one of said reference signals is detected at said communication device.

There is also provided a computer program product comprising program code means which when loaded into a computer controls the computer to: in a communication technique involving a plurality of access nodes cooperatively detecting an uplink transmission from a communication device: broadcast access node-specific reference signals from respective ones of said access nodes; and transmit information about respective transmission powers of said access-node specific reference signals.

There is also provided a computer program product comprising program code means which when loaded into a computer controls the computer to: in a communication system involving a plurality of access nodes cooperatively detecting an uplink transmission from a communication device: measure the respective received powers at which one or more earlier transmissions from said communication device is detected at each of said access nodes, determine whether any of said received powers exceeds a predetermined threshold value, and, if so, transmit to said communication device a power correction value indicative of excessive transmission power.

There is also provided a system including: a communication device and a plurality of access nodes cooperatively detecting an uplink transmission from a communication device; wherein said plurality of access nodes are configured to broadcast respective access node-specific reference signals, and transmit information about respective transmission powers of said access-node specific reference signals; and said communication device is configured to detect said access node-specific reference signals, and calculate a pathloss value for at least one of said plurality of access nodes from a measurement of a power at which a respective one of said reference signals is detected at said communication device.

Hereunder, embodiments of the present invention will be described in detail, by way of example only, with reference to the following drawings, in which:

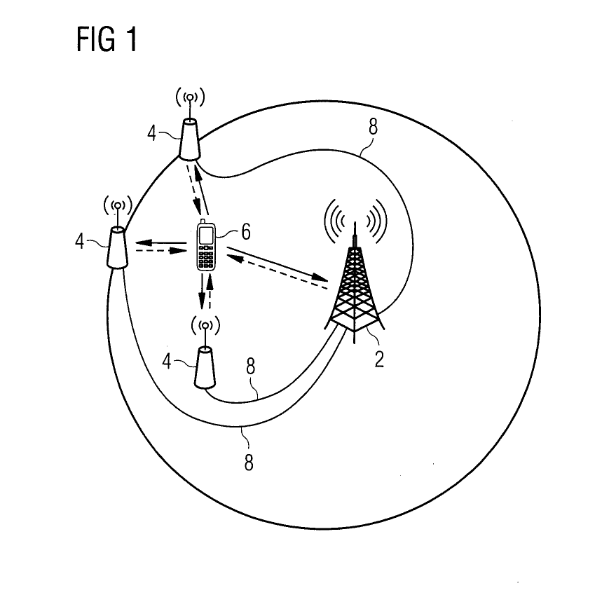

FIG. 1 illustrates an example of a heterogeneous radio access network within which embodiments of the invention may be implemented, which radio access network includes a plurality of slave access nodes commonly operating under the cell identifier of a master access node;

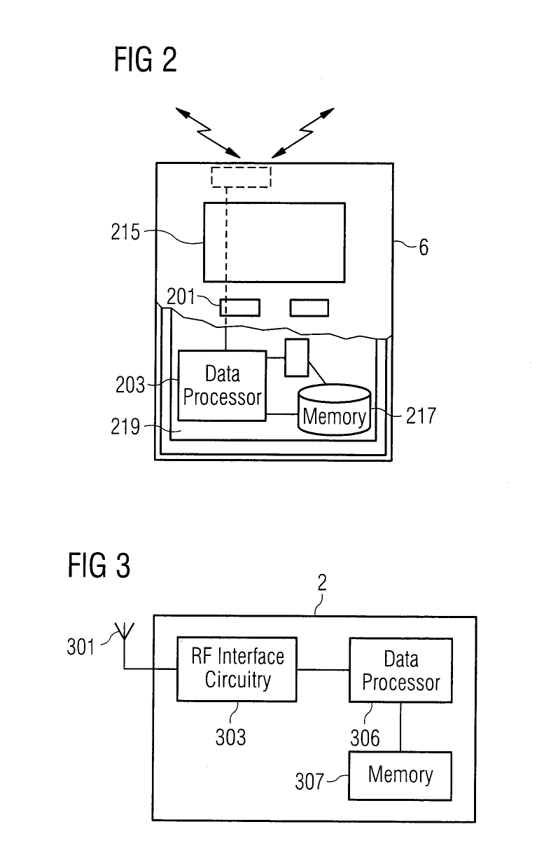

FIG. 2 illustrates an example of user equipment shown in FIG. 1 in further detail;

FIG. 3 illustrates an example of an apparatus suitable for implementing an embodiment of the invention at an access node of the network shown in FIG. 1;

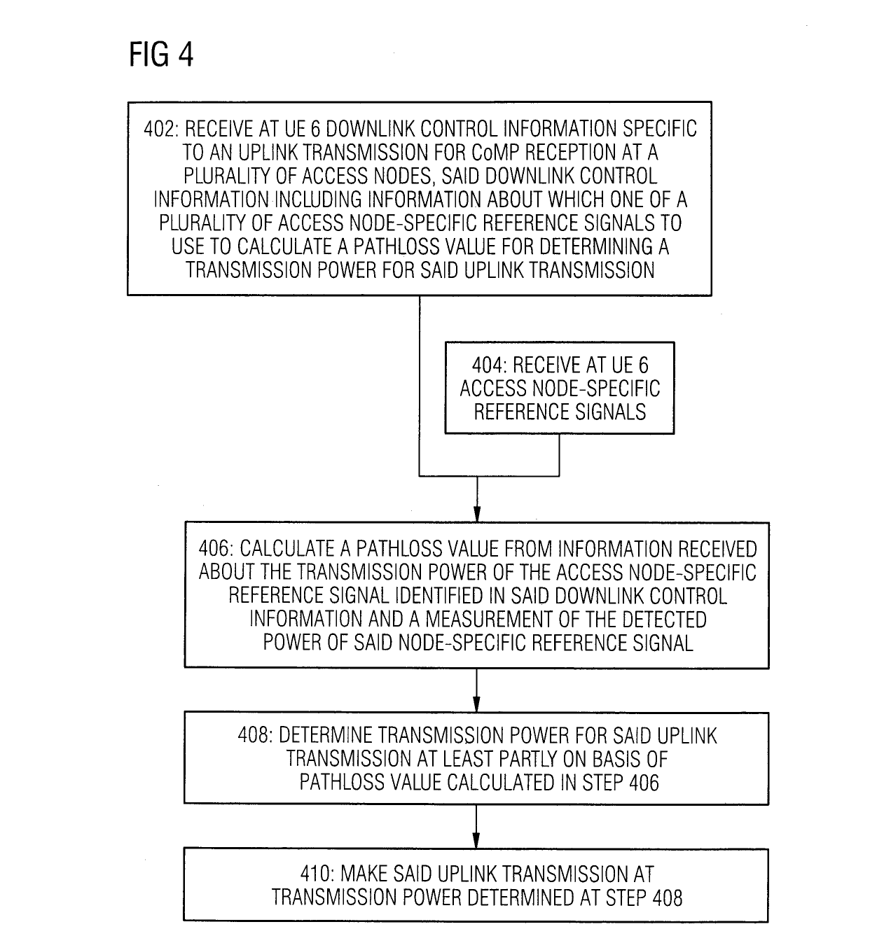

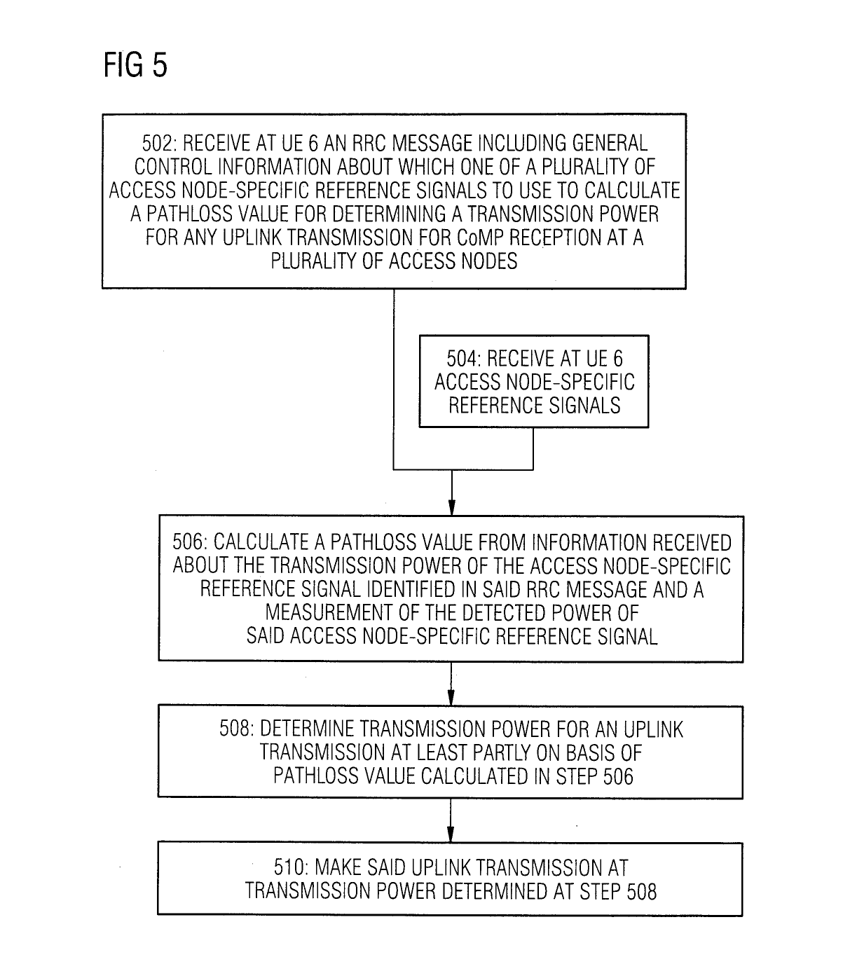

FIG. 4 illustrates an example of the operations of user equipment of FIG. 1 in accordance with an embodiment of the present invention;

FIG. 5 illustrates an alternative example of the operations of user equipment of FIG. 1 in accordance with an embodiment of the present invention;

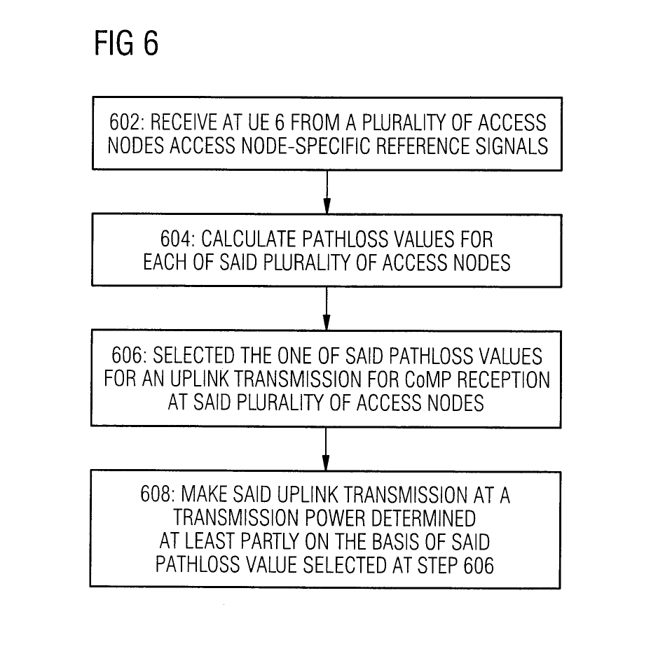

FIG. 6 illustrates another alternative example of the operations of user equipment of FIG. 1 in accordance with an embodiment of the present invention; and

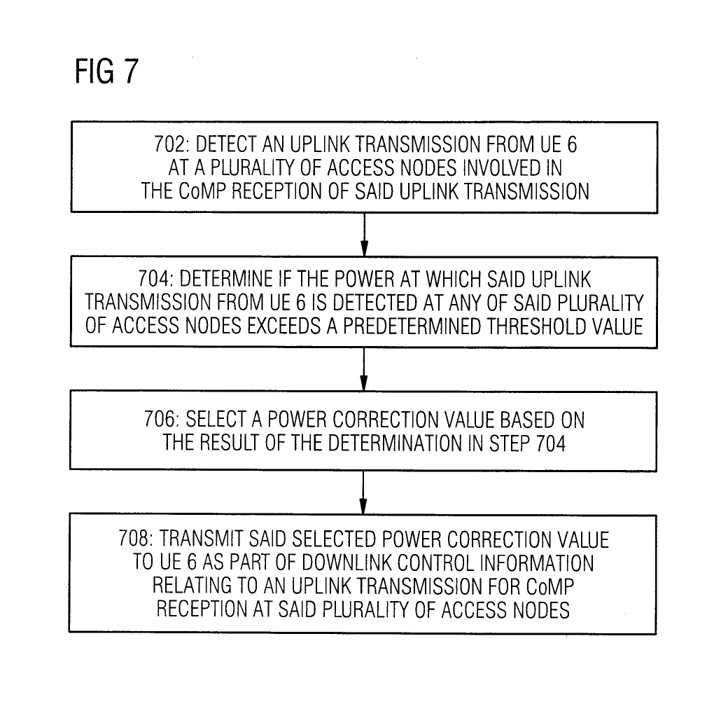

FIG. 7 illustrates an example of the operation of the radio access network of FIG. 1 in accordance with an embodiment of the present invention.

Embodiments of the invention are described below, by way of example only, in the context of a Coordinated Multi-Point (CoMP) reception system proposed as a development for a Long Term Evolution (LTE)-Advanced radio access network. However, the same kind of technique is also of use in other networks in which communicating over a wireless interface relies on involving a plurality of access nodes in the cooperative detection of a transmission from a communication device.

FIG. 1 illustrates one example of a CoMP reception technique in a heterogeneous access network where a macro eNB controls the cooperative reception of uplink signals in the macro eNB and slave access nodes such as pico eNBs or remote radio heads (RRHs). In the presented example an uplink signal from user equipment (UE) 6 is detected at multiple, geographically separated points including a macro eNodeB (eNB) 2 and a plurality of remote radio heads (RRHs) 4 operating under the control of the macro eNB 2 and under the cell identifier of the macro eNB 2. The macro eNB 2 and the RRHs 4 all operate under a common cell id and broadcast a common reference signal (CRS) common to all of the RRHs 4 and macro eNB2.

A source signal from UE 6 is reconstructed from the observations of said source signal at said macro eNB 2 and RRHs 4. Such joint signal processing enables the exploitation of large-scale spatial diversity, and can realise gains in spectral efficiency. The signal processing can, for example, be carried out at a central processing unit based on information received from the macro eNB 2 and RRHs 4, or at one or more of the macro eNB 2 and RRHs 4 following the exchange of information between the macro eNB 2 and RRHs 4.

The macro eNB 2 could, for example, be one of a large number of similar macro eNBs forming a cellular access network. The RRHs 4 are connected to the macro eNB 2 via wired links 8 such as optical fibre links.

In FIG. 1: the solid line arrows indicate the detection at the macro eNB 2 and RRHs 4 of a transmission by UE 6; and the broken line arrows indicate the detection at UE 6 of reference signals transmitted by the macro eNB 2 and RRHs 4.

FIG. 2 shows a schematic partially sectioned view of an example of user equipment 6 that may be used for communicating with the macro eNB 2 and RRHs 4 of FIG. 1 via a wireless interface. The user equipment (UE) 6 may be used for various tasks such as making and receiving phone calls, for receiving and sending data from and to a data network and for experiencing, for example, multimedia or other content.

The UE 6 may be any device capable of at least sending or receiving radio signals. Non-limiting examples include a mobile station (MS), a portable computer provided with a wireless interface card or other wireless interface facility, personal data assistant (PDA) provided with wireless communication capabilities, or any combinations of these or the like. The UE 6 may communicate via an appropriate radio interface arrangement of the UE 6. The interface arrangement may be provided for example by means of a radio part and associated antenna arrangement. The antenna arrangement may be arranged internally or externally to the UE 6.

The UE 6 may be provided with at least one data processing entity 203 and at least one memory or data storage entity 217 for use in tasks it is designed to perform. The data processor 213 and memory 217 may be provided on an appropriate circuit board 219 and/or in chipsets.

The user may control the operation of the UE 6 by means of a suitable user interface such as keypad 201, voice commands, touch sensitive screen or pad, combinations thereof or the like. A display 215, a speaker and a microphone may also be provided. Furthermore, the UE 6 may comprise appropriate connectors (either wired or wireless) to other devices and/or for connecting external accessories, for example hands-free equipment, thereto.

FIG. 3 shows an example of apparatus for use at the RRHs 4 and the macro eNB 2. The apparatus comprises a radio frequency antenna 301 configured to receive and transmit radio frequency signals; radio frequency interface circuitry 303 configured to interface the radio frequency signals received and transmitted by the antenna 301 and the data processor 306. The radio frequency interface circuitry 303 may also be known as a transceiver. The data processor 306 is configured to process signals from the radio frequency interface circuitry 303, control the radio frequency interface circuitry 303 to generate suitable RF signals to communicate information to the UE 6 via the wireless communications link. The memory 307 is used for storing data, parameters and instructions for use by the data processor 306.

It would be appreciated that both the UE 6 and the apparatus shown in FIGS. 2 and 3 respectively and described above may comprise further elements which are not directly involved with the embodiments of the invention described hereafter.

The UE 6 may be configured to perform an uplink power control procedure, such as, for example, the one specified for LTE in TS 36.213. The determining of an open-loop path-loss compensation component constitutes a part of this procedure. This path-loss compensation component P_{PL}_{_{—}}_{comp} is to ensure that signals from UEs 6 close to an access point do not drown out the signals of UEs 6 farther away in a cell. The calculation of the path-loss compensation component comprises a semi-static base level P₀, a path-loss compensation factor α and a downlink path-loss estimation PLd:

P_{PL}_{_{—}}_{comp}=P₀+α·PLd

The data processor 306 may therefore be configured to perform measurements of the signal power of reference symbols received from an access point via the radio frequency interface 303. The data processor 306 may further be configured to store and to filter the obtained measurement results. The data processor 306 may finally determine the path-loss PLd experienced by downlink reference signals based on the processed measurement results and an available reference signal power employed in the access points for the transmission of the reference signals in downlink. In systems where there can be a significant difference between the uplink pathless and downlink pathless (such as can be the case in a frequency division duplex system where there is a significant difference between the uplink and downlink frequencies, PLd is replaced by PLu, which can be derived from the determined downlink path-loss PLd, by the use of, for example, a conversion table specifying how a measured downlink pathless translates into an uplink pathless.

In the case of heterogeneous access networks like the one depicted in FIG. 1 a problem arises that there is no distinct path for data transmission to/from UE 6. Where the UE 6 cannot distinguish between reference signals from the macro eNB 2 and RRHs (or pica eNBs) 4 associated with the macro eNB 2, the path-loss calculation PLd will typically be determined by the path-loss from the macro eNB 2 which provides the strongest downlink signal even though the UE 4 may be very close to one of the RRHs (or pico eNBs) 4. There is therefore a danger that the UE 6 will therefore overestimate the path-loss value used for the power control equation and will make an uplink transmission with an excessively high uplink transmit power, which can lead to high interference at nearby access nodes and needless power consumption in the UE.

Two examples of a first embodiment are illustrated in FIG. 4. In addition to or instead of the above-mentioned reference signals common to all of the macro eNB 2 and the RRHs 4, the macro eNB 2 and the RRHs 4 each broadcast additional access node-specific reference signals detectable by UE 6 (STEPS 404 AND 504) by which the UE 6 can calculate respective pathless values for each of the access nodes. Information about the respective transmission powers at which the access nodes transmit the access-node specific reference signals is broadcast by the access network, and the respective pathloss value for each access node can be calculated from the respective received power and the transmission power.

The additional access node-specific reference signals mentioned above may, for example, be channel state information (CSI) reference signals that the UE 6 also uses for providing feedback to the access network about the quality of the respective channels between the UE 6 and the access nodes (macro eNB 2 and RRHs 4). It is sufficient that such channel state information reference signals (CSI-RS) are sent about once per channel quality information (CQI) feedback cycle.

In LTE, different CSI-RS antenna ports can be employed for the various access nodes in a heterogeneous access network and the UE 6 can distinguish the reference signals from the macro eNB 2 and the RRHs or pico eNBs 4 by determining the received reference signal powers for the configured CSI-RS antenna ports. The assignment of CSI-RS antenna ports to macro eNBs, RRHs and pico eNBs is preferably coordinated between neighbouring cells.

The UE 6 reports the path loss values or related information to the access network and the access network transmits to the UE 6 an indication of which access node to use as a reference for the uplink power control procedure. UE 6 uses the access node-specific reference signal (e.g. CSI-RS) for the access node thus identified by the access network to determine a PL value for the open-loop path-loss compensation component of the uplink power control procedure described above (STEPS 402 AND 502). UE 6 calculates a pathloss value calculated from the received power of the additional reference signal (e.g. CSI-RS) and information received from the access network about the transmission power of the additional reference signal (e.g. CSI-RS) for the access node indicated by the access network (STEPS 406 and 506). UE 6 then determines an uplink transmission power using the calculated pathloss value (STEPS 408 and 508); and makes the uplink transmission at the determined transmission power (STEPS 410 and 510).

The selection by the access network of which one of the access node-specific reference signals to use for calculating a pathless value for the uplink power control equation is performed with the aim of guaranteeing sufficient signal transmission quality for the uplink transmission whilst avoiding the uplink transmission causing excessive interference at any one of the access nodes.

According to one very dynamic example as illustrated in FIG. 4, the above-mentioned indication of which access node-specific reference signal to use to calculate a pathloss value is included as part of the downlink control information that the access network transmits to UE 6 for each scheduled uplink transmission from the UE 6, which downlink control information also identifies the radio resources allocated to the uplink transmission. UE 6 makes a scheduled uplink transmission via the radio resources identified in the downlink control information and at a transmission power determined according to the power control equation using a pathloss value calculated from the received and transmission powers of the access node-specific reference signal identified in the same downlink control information.

In order to avoid increasing the resource overhead for downlink control information, the above-mentioned indication could be included in a format field that primarily provides other control information but for which the number of allocated bits is sufficient to provide both said primary control information and the above-mentioned indication of which access node-specific reference signal to use for calculating a pathloss value for the power control equation. For example, the above-mentioned indication could be included in a format field that enables cross-carrier scheduling by providing information about which one of a plurality of component carriers to use for the uplink transmission.

Alternatively, the above-mentioned indication is included in a format field exclusively dedicated to said indication.

According to another less dynamic example as illustrated in FIG. 5, the above-mentioned indication of which access node-specific reference signal to use for calculating the pathloss value for uplink power control is provided instead in a radio resource control (RRC) message that includes control information that is valid for a longer period of time, and can be used by the UE 6 for more than one uplink transmission.

FIG. 6 illustrates another embodiment. In this embodiment, UE 6 detects the same access node-specific reference signals (STEP 602), but UE 6 does not receive any indication from the access network as to which of the access node-specific reference signals to use for calculating a pathloss value for the power control equation. Instead UE 6 adopts a more autonomous approach. UE 6 calculates a pathloss value for each of the access node-specific reference signals (STEP 604), and selects one of those pathloss values (STEP 606). The selected path loss value may not necessarily be the lowest of the pathloss values, if, for example, one or more other parameters of the above-mentioned pathloss compensation component P_{PL}_{_{—}}_{comp} (such as P₀ or α are different for different ones of the access nodes. This autonomous selection by UE 6 may, for example, be carried out with the aim of guaranteeing signal transmission quality but not creating excessive interference to other cells.

UE 6 makes the uplink transmission at a transmission power determined according to the above power control equation using the pathloss value selected by UE 6 (STEP 608).

For any UE 6 that does not have capability to detect the additional access-node specific reference signals and calculate a pathloss value for a specific one of the access nodes, such UE 6 instead calculates a pathloss value from (i) a measurement of the received power of the reference signal common to all the access nodes and (ii) information about the power at which the macro eNB 2 transmits said common reference signal. In order to deal with the possibility that the transmission power determined on this basis may cause excessive interference at one or more of the RRHs 4, the access network monitors the power at which each of the access nodes (macro eNB 2 and RRHs 4) detect uplink transmissions from UE 6, and accordingly selects a power correction value (transmission power command TPC) for transmission to the UE 6 as part of a closed-loop component of the power control technique. For example, if the access network determines that the power at which any of the access nodes (eNB 2 and RRHs 4) detects a transmission from UE 6 exceeds a predetermined threshold value, the access network transmits to UE 6 a negative power correction value (TPC command), which the UE 6 takes into account when determining an uplink transmission power for the one or more uplink transmissions for which the power correction value (TPC) is relevant. The power correction value (TPC) can be included in a physical downlink control channel (PDCCH).

The techniques described above can be useful, for example, in avoiding excessive degradation to the overall uplink capacity of the access network and avoiding excessive power demands on the UE 6.

Mention has been made above of the power control procedure specified for LTE in 3GPP-TS 36.213, but the above-described techniques could be applied, for example, to any power control technique including an open-loop component based on a pathloss value.

Also, the access-node specific reference signals used to calculate a transmission point-specific pathloss value can also be used for other purposes, such as the radio resource management (RRM) procedures at the time of handing over a UE 6 from one eNB 2 to another eNB 2.

The techniques described above are effective for avoiding excessive interference problems at any one access node that happens to be particularly close to the UE 6.

The above-described operations may require data processing in the various entities. The data processing may be provided by means of one or more data processors. Similarly various entities described in the above embodiments may be implemented within a single or a plurality of data processing entities and/or data processors. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a server.

For example the embodiments of the invention may be implemented as a chipset, in other words a series of integrated circuits communicating among each other. The chipset may comprise microprocessors arranged to run code, application specific integrated circuits (ASICs), or programmable digital signal processors for performing the operations described above.

Embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) maybe transmitted to a semiconductor fabrication facility or “fab” for fabrication.

In addition to the modifications explicitly mentioned above, it will be evident to a person skilled in the art that various other modifications of the described embodiment may be made within the scope of the invention.

1-51. (canceled)

52. A method, comprising: as part of a communication technique involving a plurality of access nodes cooperatively detecting an uplink transmission from a communication device: detecting at said communication device access node-specific reference signals transmitted by respective ones of said plurality of access nodes; and calculating a pathloss value for at least one of said plurality of access nodes from a measurement of a power at which a respective one of said reference signals is detected at said communication device.

53. A method according to claim 52, comprising: determining a transmission power parameter for said uplink transmission from said communication device at least partly on the basis of a pathloss value calculated from a measurement of a power at which one of said reference signals is received at said communication device, and information received at the communication device about a transmission power for said one of said reference signals.

54. A method according to claim 52, further comprising: receiving at said communication device an indication as to which of said access-node specific reference signals to use for determining said transmission power parameter.

55. A method according to claim 54, comprising: receiving said indication as part of downlink control information specific to said uplink transmission.

56. A method according to claim 52, comprising determining at said communication device respective pathloss values for each of said plurality of access nodes, and determining said transmission power parameter on the basis of one of said pathloss values selected according to a predetermined rule.

57. A method according to claim 52, further comprising detecting at said communication a reference signal common to all of said plurality of access nodes and broadcast by all of said plurality of access nodes.

58. A method according to claim 52, wherein said plurality of access nodes includes a set of access nodes operating under the control of another of said plurality of access nodes.

59. A method, comprising: in a communication technique involving a plurality of access nodes cooperatively detecting an uplink transmission from a communication device: broadcasting access node-specific reference signals from respective ones of said access nodes; and transmitting information about respective transmission powers of said access-node specific reference signals.

60. A method according to claim 59, further comprising: transmitting to said communication device an indication as to which of said access-node reference signals to use for determining a transmission power parameter for said uplink transmission.

61. An apparatus comprising: a processor and memory including computer program code, wherein the memory and computer program code are configured to, with the processor, cause the apparatus to: as part of a communication technique involving a plurality of access nodes cooperatively detecting an uplink transmission from a communication device: detect at said communication device access node-specific reference signals transmitted by respective ones of said plurality of access nodes; and calculate a pathloss value for at least one of said plurality of access nodes from a measurement of a power at which a respective one of said reference signals is detected at said communication device.

62. An apparatus according to claim 61, wherein said memory and computer program code are configured to, with the processor, cause the apparatus to: determine a transmission power parameter for said uplink transmission from said communication device at least partly on the basis of a pathloss value calculated from a measurement of a power at which one of said reference signals is received at said communication device, and information received at the communication device about a transmission power for said one of said reference signals.

63. An apparatus comprising: a processor and memory including computer program code, wherein the memory and computer program code are configured to, with the processor, cause the apparatus to: in a communication technique involving a plurality of access nodes cooperatively detect an uplink transmission from a communication device: broadcast access node-specific reference signals from respective ones of said access nodes; and transmit information about respective transmission powers of said access-node specific reference signals.

64. An apparatus according to claim 63, wherein said memory and computer program code are configured to, with the processor, cause the apparatus to: transmit to said communication device an indication as to which of said access-node reference signals to use for determining a transmission power parameter for said uplink transmission.

65. A computer program product comprising program code means which when loaded into a computer controls the computer to: as part of a communication technique involving a plurality of access nodes cooperatively detecting an uplink transmission from a communication device: detect at said communication device access node-specific reference signals transmitted by respective ones of said plurality of access nodes; and calculate a pathloss value for at least one of said plurality of access nodes from a measurement of a power at which a respective one of said reference signals is detected at said communication device.

66. A computer program product comprising program code means which when loaded into a computer controls the computer to: in a communication system involving a plurality of access nodes cooperatively detecting an uplink transmission from a communication device: measure the respective received powers at which one or more earlier transmissions from said communication device is detected at each of said access nodes, determine whether any of said received powers exceeds a predetermined threshold value, and, if so, transmit to said communication device a power correction value indicative of excessive transmission power.
